(19) United States
(12) Patent Application Publication
(10) Pub. No.: US 2022/0033634 A1
(43) Pub. Date: Feb. 3, 2022

(54) CURABLE FLUORINE-BASED ELASTOMER COMPOSITE AND CURED PRODUCT THEREOF

(71) Applicant: 3M INNOVATIVE PROPERTIES COMPANY, St. Paul, MN (US)

(72) Inventors: Tamon Aoki, Tokyo (JP); Yuta Suzuki, Sagmihara-shi, Kanagawa (JP)

(21) Appl. No.: 17/279,867

(22) PCT Filed: Sep. 19, 2019
(86) PCT No.: PCT/IB2019/057942

§ 371 Date: Mar. 25, 2021

(30) Foreign Application Priority Data
Sep. 26, 2018 (JP) 2018-180486

(51) Int. Cl. C08L 27/18

(52) U.S. Cl. CPC C08L 27/18; C08L 2312/00; C08L 2205/025

(57) ABSTRACT

A curable fluorine-based elastomer composite containing a curable fluorine-based polymer including a curable fluorine-based elastomer including a copolymerization unit having a curing site; a crosslinking agent that reacts with a curing site to form a crosslinking unit in the elastomer; and a crosslinking aid including an organic onium salt, in which the total content of the crosslinking agent and the crosslinking aid is about 0.5 parts by mass or more and about 3 parts by mass or less with reference to 100 parts by mass of the curable fluorine-based polymer, and the ratio between the crosslinking agent and the crosslinking aid is from about 2:8 to about 7:3.

### FIELD

The present disclosure relates to a curable fluorine-based elastomer composite and a cured product thereof.

### SUMMARY

In one aspect, the present disclosure provides a curable fluorine-based elastomer composite, comprising: a curable fluorine-based polymer comprising a curable fluorine-based elastomer including a copolymerization unit having a curing site; a crosslinking agent that reacts with a curing site to form a crosslinking unit in the elastomer; and a crosslinking aid including an organic onium salt, in which the total content of the crosslinking agent and the crosslinking aid is about 0.5 parts by mass or more and about 3 parts by mass or less with reference to 100 parts by mass of the curable fluorine-based polymer, and the ratio between the crosslinking agent and the crosslinking aid is from about 2:8 to about 7:3. In some embodiments, the curable fluorine-based polymer further comprises a curable fluorine-based plastic including a copolymerization unit having a curing site, and the curing site of the curable fluorine-based plastic may react with a crosslinking agent to form crosslinking units in the plastic.

In another aspect, the present disclosure provides a cured product of the composite, without causing cracking or melting, and having a compression set of about 88% or less after being held at 300° C. for 14 days.

In yet another aspect, the present disclosure provides a sealing material for high temperature environment obtained from a cured product of the composite.

### BRIEF DESCRIPTION OF DRAWINGS

FIG. 1 is a graph illustrating the compression set in a cured product of the composite according to an embodiment of the present disclosure after the lapse of 72 to 336 hours in an atmosphere at 300° C.

FIG. 2 is a graph illustrating the compression set versus the blending ratio of a crosslinking agent and a crosslinking aid in a cured product of a composite according to an embodiment of the present disclosure after exposure for 336 hours at 300° C.

FIG. 3 is a graph illustrating the compression set in a cured product of a composite according to another embodiment of the present disclosure after the lapse of 72 to 336 hours in an atmosphere at 300° C.

FIG. 4 is a graph illustrating the compression set versus the blending ratio of the crosslinking agent and the crosslinking aid after exposure for 336 hours at 300° C. in a cured product of a composite according to another embodiment of the present disclosure.

FIG. 5 is a graph illustrating the compression set in a comparative fluorine-based elastomer composition after the lapse of 72 to 336 hours in an atmosphere at 300° C.

FIG. 6 is a graph illustrating the compression set in a cured product of a composite according to yet another embodiment of the present disclosure after the lapse of 72 to 336 hours in an atmosphere at 300° C.

### BACKGROUND

Fluorine-based materials have excellent properties such as chemical resistance and heat resistance, and thus are widely used as, for example, sealing materials and packing materials for semiconductor manufacturing processes, chemical plants, automobiles, and aircrafts.

Patent Document 1 (JP 2013-107924 A) discloses a fluoropolymer composition including a fluoropolymer and a crosslinking agent, wherein the fluoropolymer is an elastomer including a copolymerization unit derived from a nitrogen-containing curing site monomer, and the crosslinking agent is a combination of two or more compounds including one or more amidine compounds and one or more bisaminophenol compounds.

A fluorine-based elastomer (rubber) having excellent properties such as chemical resistance and heat resistance is used as a material of sealing materials for keeping a vacuum in process chambers for processing wafers. In recent years, such materials used in these applications are required to have higher levels of heat resistance.

### DETAILED DESCRIPTION

The curable fluorine-based elastomer composites of the present disclosure comprise: a curable fluorine-based polymer comprising a curable fluorine-based elastomer including a copolymerization unit having a curing site; a crosslinking agent that reacts with a curing site to form a crosslinking unit in the elastomer; and a crosslinking aid including an organic onium salt, wherein the total content of the crosslinking agent and the crosslinking aid is about 0.5 parts by mass or more and about 3 parts by mass or less with reference to 100 parts by mass of the curable fluorine-based polymer, and the ratio between the crosslinking agent and the crosslinking aid is from about 2:8 to about 7:3. The composite includes a specific crosslinking agent and a specific crosslinking aid at a specific ratio, and thus provides a cured product having excellent long-term high temperature resistance.

The curable fluorine-based polymer of the composite may further include a curable fluorine-based plastic including a copolymerization unit having a curing site, and the curing site of the curable fluorine-based plastic may react with a crosslinking agent to form crosslinking units in the plastic. The composite also includes a specific crosslinking agent and a specific crosslinking aid at a specific ratio, and thus provides a cured product having excellent long-term high temperature resistance.

The curing site of the curable fluorine-based elastomer and the curable fluorine-based plastic of the composite may be a cyano group. The fluorine-based elastomer and the fluorine-based plastic having the curing site have excellent reactivity, and thus have further improved long-term high temperature resistance.

The curable fluorine-based elastomer of the composite may be a curable perfluoroelastomer. The elastomer can further improve properties such as heat resistance and chemical resistance.

The crosslinking agent can impart flexibility to the fluorine-based elastomer after curing, and thus can improve defects such as cracking and fracture. The crosslinking agent of the composite may be a bisaminophenol compound. The bisaminophenol compound used in the crosslinking agent of the composite may be 4,4′-(hexafluoroisopropyridine)bis(2-aminophenol). The bisaminophenol compound can further improve the properties of the cured product such as flexibility and long-term high temperature resistance.

The cationic component of the organic onium salt as the crosslinking aid of the composite may be an ammonium cation or a phosphonium cation. The combination of the crosslinking aid including the organic onium salt and the crosslinking agent can further improve the long-term high temperature resistance of the cured product.

The anionic component of the organic onium salt as the crosslinking aid of the composite may be an anionic component having at least one trifluoromethyl group. The organic onium salt may be a salt of an alcohol having at least one trifluoromethyl group and onium. The organic onium salt may be a salt of (trifluoromethyl)benzyl alcohol or perfluoro-t-alcohol and tetramethyl ammonium or tetrabutyl phosphonium. The organic onium salt may be a salt of 4-methyl-α, α-bis (trifluoromethyl)benzylmethanol and tetrabutyl phosphonium. The organic onium salt may be a salt of perfluoro-t-butanol and tetramethyl ammonium.

The organic onium salt has excellent compatibility with the curable fluorine-based polymer, and the combination of the crosslinking aid including the organic onium salt and the crosslinking agent can particularly improve the long-term high temperature resistance of the cured product.

The composite may further include a filler. The inclusion of a filler further improves the strength of the cured product obtained from the composite.

The cured product of the present disclosure is obtained by curing the composite, and the cured product can have a compression set of about 88% or less without causing cracking or melting after being held at 300° C. for 14 days. Because the composite includes a specific crosslinking agent and a specific crosslinking aid at a specific ratio, the cured product obtained from the composite has excellent long-term high temperature resistance.

The sealing material for high temperature environment of the present disclosure may be a cured product of the composite. Since the cured product obtained from the composite has excellent long-term high temperature resistance, it can be suitable as a sealing material used in a high temperature environment.

The use of the cured product of the present disclosure can mean the use the cured product obtained by curing the composite as a sealing material in a high temperature environment at 200° C. or higher. Since the cured product obtained from the composite has excellent long-term high temperature resistance, it is suitable as a sealing material used in high temperature environments.

Representative embodiments of the present invention are described in detail below for the purpose of illustration by example, but the present invention is not limited to these embodiments.

In the present disclosure, “composite” may mean a blend, formulation, or mixture of two or more components.

In the present disclosure, “curing” may also include the concepts commonly referred to as “crosslinking.” The curable fluorine-based elastomer of the present disclosure has rubber elasticity as an elastomer even after curing.

In the present disclosure, “heat resistance” or “high temperature resistance” can mean that the rate of change in rubber elasticity is low from an initial state over an extended period of time in a high temperature environment and/or the ability to be used continuously in a high temperature environment without causing cracking or melting. The high temperature environment can be defined as, for example, about 200° C. or higher, about 220° C. or higher, about 250° C. or higher, about 280° C. or higher, or about 300° C. or higher, and can be defined as about 360° C. or lower, about 340° C. or lower, or about 320° C. or lower. The period can be defined as, for example, about 5 days or more, about 7 days or more, or about 10 days or more, and can be defined as about 90 days or less, about 60 days or less, and about 30 days or less.

In the present disclosure, “chemical resistance” may include various chemical resistance such as oil resistance, alcohol resistance, acid resistance, and alkaline resistance. Specific examples of the chemicals include hydrocarbons such as n-hexane, isooctane, benzene, toluene, and ethylene gas; fuels used in various vehicles, ships, and aircrafts; oils such as lubricating oils used in various manufacturing apparatus; aldehydes such as formaldehyde; alcohols such as ethanol and ethylene glycol; sulfur-containing compounds such as carbon disulfide; phosphorus compounds such as tricresyl phosphate; acids such as hydrochloric acid and sulfuric acid; alkalis such as ammonia water and sodium hydroxide; and phenol, chlorine, bromine, and hydrogen peroxide.

In the present disclosure, “plasma resistance” can mean the ability to be usable in a plasma environment. Examples of the plasma environment include a plasma environment employed in a semiconductor manufacturing apparatus, and in particular, plasma environments such as a plasma etching device composing the apparatus, and a plasma CVD device.

In the present disclosure, the term “alkyl” means a linear or branched aliphatic hydrocarbon group. In the present disclosure, the term “branched” means one or more alkyl groups, such as methyl, ethyl or propyl is bonded to a linear alkyl chain. The alkyl group may be unsubstituted or substituted with one or more halo atoms, cycloalkyl groups, or cycloalkenyl groups.

In the present disclosure, the term “cycloalkyl” refers to a non-aromatic monocyclic or polycyclic ring system, and includes, for example, about 3 to about 12 carbon atoms. Examples of the cycloalkyl ring include cyclopentyl, cyclohexyl, and cycloheptyl. The cycloalkyl group may be substituted with one or more halo atoms, methylene, alkyl, cycloalkyl, heterocyclyl, aralkyl, heteroaralkyl, aryl, or heteroaryl. In the present disclosure, the term “hetero” means oxygen, nitrogen, or sulfur that substituted one or more carbon atoms.

In the present disclosure, the term “cycloalkenyl” refers to a non-aromatic monocyclic or polycyclic ring system having a carbon-carbon double bond, and includes, for example, about 3 to about 10 carbon atoms. The cycloalkenyl group may be unsubstituted and substituted with one or more halo atoms, methylene, alkyl, cycloalkyl, heterocyclyl, aralkyl, heteroaralkyl, aryl, or heteroaryl groups.

In the present disclosure, the term “aryl” means an aromatic carbocyclic radical. Examples of the aryl groups include phenyl or naphthyl substituted with one or more aryl group substituents, which may be identical or different. Examples of the “aryl group substituent” include hydrogen, alkyl, cycloalkyl, optionally substituted aryl, optionally substituted heteroaryl, aralkyl, aralkenyl, aralkynyl, heteroaralkyl, heteroaralkenyl, heteroaralkynyl, hydroxy, hydroxyalkyl, alkoxy, aryloxy, aralkoxy, carboxy, acyl, aroyl, halo, nitro, cyano, carboxy, alkoxycarbonyl, aryloxycarbonyl, aralcoxy carbonyl, acylamino, aroylamino, alkylsulfonyl, arylsulfonyl, and other known groups.

The descriptions of the chemical groups listed above are known in the art, and these descriptions are not intended to change the meaning generally recognized.

### Curable Fluorine-Based Elastomer Composite

The components of the curable fluorine-based elastomer composite (may be simply referred to as “composite” hereafter) will be further described below.

### Curable Fluorine-Based Polymer

The curable fluorine-based polymer of the present disclosure includes a curable fluorine-based elastomer described below, and may optionally include a curable fluorine-based plastic. The composites of the present disclosure may also optionally include a non-curable fluorine-based plastic, and curable or non-curable fluorine-based plastics may be generally referred to simply as “fluorine-based plastics”.

### Curable Fluorine-Based Elastomer

The curable fluorine-based elastomer of the present disclosure (may be simply referred to as “elastomer”) includes a copolymerization unit having a curing site. The copolymerization units are derived from a monomer having a curing site (may be referred to simply as “curing site monomer”), and may be, for example, a monomer including a nitrogen-containing curing site (i.e., a structural moiety that contains nitrogen and contributes to a curing reaction) (may be referred to simply as “nitrogen-containing curing site monomer). Examples of the nitrogen-containing curing site include a cyano group (nitrile group), an imidate group, an amidine group, an amide group, an imide group, and an amine-oxide group. Among these, a cyano group (nitrile group) is preferable. The nitrogen-containing curing site monomer may be partially or fully fluorinated.

The nitrogen-containing curing site monomer may be one or more types selected from, but not limited to, for example, cyano-containing fluorinated olefins and cyano-containing fluorinated vinyl ethers. These are preferably perfluorinated from the perspective of heat resistance, chemical resistance, and the like. Examples of the cyano-containing fluorinated vinyl ethers include CF₂=CFO(CF_{2L}CN; CF₂=CFO[CF₂CF(CF₃)O]_{q}(CF₂O)_{y}CF(CF₃)CN; CF₂=CF[OCF₂CF(CF₃)]ᵣO(CF₂)ₜCN; and CF₂=CFO(CF₂)ᵤOCF(CF₃)CN. Where L is an integer of 2 to 12; q is an integer of 0 to 4; r is an integer of 1 to 2; y is an integer of 0 to 6; t is an integer of 1 to 4; u is an integer of 2 to 6.

Representative examples of useful nitrogen-containing curing site monomers include CF₂=CFO(CF₂)₃OCF(CF₃)CN, perfluoro (8-cyano-5-methyl-3,6-dioxa-1-octene), and CF₂=CFO(CF₂)₅CN (MV5CN).

The copolymerization units derived from the curing site monomer preferably make up about 0.1 to about 5 mol %, or about 0.3 to about 2 mol % of the total polymerization units in the curable fluorine-based elastomer. These ranges are advantageous from the perspective of imparting favorable surface properties to the molded article obtained from the curable fluorine-based elastomer composite of the present disclosure.

Preferable examples of the curable fluorine-based elastomer include elastomers including copolymerization units derived from a curing site monomer and a main monomer (preferably at least two main monomers). Examples of the main monomer include perfluoroolefins (e.g., tetrafluoroethylene (TFE) and hexafluoropropylene (HFP)), other perhalogenated olefins (e.g., chlorotrifluoroethylene (CTFE)), and perfluorovinyl ethers (e.g., perfluoroalkyl vinyl ethers and perfluoroalkyl vinyl ethers). In some cases, hydrogen-containing monomers such as olefins (e.g., ethylene and propylene) and partially fluorinated monomers (e.g., vinylidene fluoride (VDF)) may also be used.

In a case where the curable fluorine-based elastomer is perhalogenated, the curable fluorine-based elastomer may include at least about 50 mol % of copolymerization units derived from one or more perhalogenated olefins (e.g., TFE and/or CTFE, optionally HFP). The remainder of the copolymerization units of the curable fluorine-based elastomer (e.g., about 10 to about 50 mol %) may be composed of one or more perfluorovinyl ethers and one or more curing site monomers (e.g., cyano-containing vinyl ethers or imidate-containing vinyl ethers). The curable fluorine-based elastomer is preferably perfluorinated from the perspective of heat resistance, chemical resistance, and the like.

On the other hand, in an aspect in which the curable fluorine-based elastomer is not perhalogenated, the curable fluorine-based elastomer may include, for example, about 5 to about 90 mol % of copolymerization units derived from a perhalogenated olefin, about 5 to about 90 mol % of copolymerization units derived from a hydrogen-containing monomer (e.g., a hydrogen-containing olefin), 40 mol % or less of copolymerization units derived from a vinyl ether, and about 0.1 to about 5 mol % (more preferably about 0.3 to about 2 mol %) of copolymerization units derived from a curing site monomer.

In an aspect in which the curable fluorine-based elastomer is not perfluorinated, the curable fluorine-based elastomer may include, for example, about 5 to about 90 mol % of copolymerization units derived from TFE, CTFE, and/or HFP, about 5 to about 90 mol % of copolymerization units derived from VDF, ethylene, and/or propylene, about 40 mol % or less of copolymerization units derived from a vinyl ether, and about 0.1 to about 5 mol % (more preferably about 0.3 to about 2 mol %) of copolymerization units derived from a curing site monomer.

A preferable example of the perhalogenated olefin is a perfluorinated olefin, and particularly preferable example of which is a perfluorinated olefin represented by Formula CF₂=CF—R_{f} (wherein R_{f} represents fluorine or C₁ to C₈ perfluoroalkyl).

A preferable example of the hydrogen-containing olefin is a hydrogen-containing C₂ to C₉ olefin in which less than ½ or less than ¼ of the hydrogen atoms in the molecule have been substituted with fluorine or are not fluorinated. However, in some embodiments, the copolymerization units derived from a non-fluorinated olefin is not included in the curable fluorine-based elastomer.

Preferable examples of the hydrogen-containing olefin are the olefins represented by the formula CX₂=CX—R (wherein Xs are each independently hydrogen, fluorine, or chlorine, and R is hydrogen, fluorine, or C₁ to C₁₂ alkyl or C₁ to C₃ alkyl). Preferable examples of these olefins are partially fluorinated monomers (e.g., vinylidene fluoride) and hydrogen-containing monomers (e.g., α-olefins such as ethylene, propylene, butene, pentene, and hexene).

Each of the aforementioned raw materials may be used in combination of two or more of them.

Examples of the perfluorovinyl ether include CF₂=CFOCF₃, CF₂=CFOCF₂CF₂OCF₃, CF₂=CFOCF₂CF₂CF₂OCF₃, CF₂=CFOCF₂CF₂CF₃, CF₂=CFOCF₂CF(CF₃)OCF₂CF₂CF₃, and CF₂=CFOCF₂CF(CF₃)OCF₂CF(CF₃)OCF₂CF₂CF₃.

The curable fluorine-based elastomer is preferably a curable perfluoroelastomer from the perspective of heat resistance, chemical resistance, and the like.

In a more preferred aspect, the curable fluorine-based elastomer is, for example, a copolymer of a perfluoroolefin, a perfluorovinyl ether, and a nitrogen-containing curing site monomer. In the copolymer, a preferable example of the nitrogen-containing curing site monomer is one or more types selected from cyan-containing fluorinated olefins and cyano-containing fluorinated vinyl ethers.

In a more preferable aspect, the curable fluorine-based elastomer is, for example, a copolymer of tetrafluoroethylene (TFE), at least one perfluoroalkyl vinyl ether, and a nitrogen-containing curing site monomer (preferably one or more types selected from cyano-containing fluorinated olefins and cyano-containing fluorinated vinyl ethers).

In a particularly preferred aspect, the curable fluorine-based elastomer is a ternary copolymer of tetrafluoroethylene (TFE), perfluoromethyl vinyl ether (PMVE), and CF₂=CFO(CF₂)₅CN (MV5CN).

In these copolymers, the copolymerized perfluorovinyl ether units (preferably perfluoroalkyl vinyl ether units, more preferably PMVE units) may make up, preferably from about 1 to about 60 mol %, and more preferably from about 10 to about 40 mol % of the total copolymerization units of the curable fluorine-based elastomer.

The curable fluorine-based elastomer may be one type or a blend of two or more types of them. In the blend, each elastomer includes a copolymerization unit derived from the above-described curing site monomer. For example, two or more types of elastomers including a reactive site may be blended so as to be suitable for the combination with the crosslinking agent to be used.

### Fluorine-Based Plastic

The composite of the present disclosure may include, as an optional component, one or more curable or non-curable fluorine-based plastics that are different from the curable fluorine-based elastomer. The fluorine-based plastic may be a homopolymer or a copolymer. The fluorine-based plastic may be blended with a curable fluorine-based elastomer. The fluorine-based plastic may or may not include copolymerization units derived from curing site monomers.

The polymerization unit of the fluorine-based plastic may be, for example, those described above as copolymerization units that may be included in a curable fluorine-based elastomer. The obtained fluorine-based plastic is different from the curable fluorine-based elastomer, and, for example, a fluorine-based plastic that does not exhibit elastomer property (rubber elasticity) may be employed. Examples thereof include ternary copolymers of tetrafluoroethylene, perfluoro(propylvinyl ether) and CF₂=CFO(CF₂)₅CN (MV5CN).

In a case where the fluorine-based plastic includes a copolymerization unit having a curing site similar to that of the curable fluorine-based elastomer, and the crosslinking agent reacts with the curing site to form a crosslinking unit in the fluorine-based resin (this fluorine-based plastic may be referred to as “curable fluorine-based plastic”), the total loading of the crosslinking agent and the crosslinking aid described below may be about 0.5 parts by mass or greater and about 3 parts by mass or less with reference to 100 parts by mass of the curable fluorine-based elastomer and the curable fluorine-based plastic.

For example, desired properties can be imparted to the composite by combining the fluorine-based plastic and an optional curing agent that can be used in addition to the crosslinking agent of the present disclosure. For example, improvement of chemical stability of the composite is expected by combining a fluorine-based plastic suitable for peroxide curing and a peroxide curing agent. The use of such fluorine-based plastics and additional curing agent can, for example, balance the heat resistance and chemical stability of the resulting blend, as well as achieving economic benefits.

When a fluorine-based plastic is used, the mass ratio of the curable fluorine-based elastomer may be about 25% by mass or greater or about 50% by mass or greater with reference to the total of the curable fluorine-based elastomer and the fluorine-based plastic (they may be referred to collectively as “fluorine-based polymers”) included in the composite. In this case, for example, a composite that provides a molded product having excellent surface characteristics can be obtained. In some aspects, the fluorine-based polymer component included in the composite may be only a curable fluorine-based elastomer.

### Method for Preparing Fluorine-Based Polymer

The curable fluorine-based elastomer and fluorine-based plastics as optional components can be prepared using known methods. For example, the polymerization process can be carried out by free-radical polymerization of monomers by aqueous emulsion polymerization or solution polymerization in an organic solvent. For example, when a blend of two or more types of fluorine-based plastic is prepared, a latex of two or more types of fluorine-based plastic are blended at a selected ratio, coagulated, and then dried.

In the curable fluorine-based elastomer and fluorine-based plastics as optional components, the types and amounts of the end groups are not critical. For example, the fluorine-based plastic may include SO₃⁻ end groups generated by an APS/sulfite system. Alternatively, the fluorine-based plastic may include COO⁻ end groups generated by an APS polymerization initiator system. Alternatively, the fluorine-based plastic may include “neutral” end groups, such as those generated by the use of a fluorosulfonate polymerization initiator system or an organic peroxide. The number of end groups can be remarkably reduced by using any chain transfer agent. Optionally, for example, in order to improve processability, the presence of highly polar end groups such as SO₃⁻ end groups may be minimized. Also, if desired, the amount of COO⁻ or other unstable end groups may be reduced by known post-treatment (e.g., decarboxylation or post-fluorination).

The curable fluorine-based elastomer and/or optional curable fluorine-based plastic, which are curable fluorine-based polymers, may also include a curing site other than a nitrogen-containing curing site. They may include, for example, halogens such that they can participate in a peroxide curing reaction. The halogen can be present in the polymer chain and/or at the terminal position in the curable fluorine-based polymer. The halogen may typically be bromine or iodine.

The method for introducing halogen at a position in the polymer chain in the curable fluorine-based polymer is preferably copolymerization. When this method is used, suitable fluorinated curing site monomers, such as a bromo- or iodo-fluoroolefin, or a bromo- or iodo-fluorovinyl ether is used as a copolymerization component. Examples of the bromo- or iodo-fluoroolefin include bromodifluoroethylene, bromotrifluoroethylene, iodotrifluoroethylene, 1-bromo-2,2-difluoroethylene, and 4-bromo-3,3,4,4-tetrafluorobutene-1. Other examples of the bromo- or iodo-fluorovinyl ethers include BrCF₂OCF=CF₂, BrCF₂CF₂OCF=CF₂, BrCF₂CF₂CF₂OCF=CF₂, and CF₃CF(Br)CF₂OCF=CF₂. Furthermore, non-fluorinated bromo- or iodo-olefins, such as vinyl bromide and 4-bromo-1-butene may also be used.

The amount of the curing site present at the polymer side chain position in the curable fluorine-based polymer may generally be about 0.05 to about 5 mol %, more preferably about 0.1 to about 2 mol % of the total polymerization units.

The curing site may be at the ends of the polymer chain in the curable fluorine-based polymer. For example, halogen can be introduced at the terminal positions by using a chain transfer agent or polymerization initiator. In general, at the time of polymer preparation, a curing site is introduced at the terminal positions by introducing an appropriate chain transfer agent into the reaction medium or by inducing it from an appropriate polymerization initiator.

Examples of the useful chain transfer agent include the compound represented by Formula R_{f}Zₓ (wherein R_{f} is a substituted or unsubstituted C₁ to C₁₂ fluoroalkyl radical that may be perfluorinated, Z is Br or I, and x is 1 or 2). Specific examples containing bromine include CF₂Br₂, Br(CF₂)₂Br, Br(CF₂)₄Br, CF₂(Cl)Br, and CF₃CF(Br)CF₂Br.

Examples of the useful polymerization initiator include the compound represented by NaO₂S(CF₂)ₙX (wherein X is Br or I, and n is an integer from 1 to 10).

The amount of the curing site present at the terminal position of the polymer in the curable fluorine-based polymer may generally be about 0.05 to about 5 mol %, more preferably from about 0.1 to about 2 mol % of the total polymerization units.

Combinations of two or more curing sites are also useful in the present invention. For example, curable fluorine-based polymers that include halogen capable of participating in a peroxide curing reaction together with a nitrogen-containing curing site, such as a cyano group-containing curing site are useful. In general, the total amount of curing sites may be from about 0.1 to about 5 mol %, more preferably from about 0.3 to about 2 mol % of the total polymerization units.

### Crosslinking Agent

The crosslinking agent used in the composite of the present disclosure may be any crosslinking agent that reacts with the curing site of the curable fluorine-based polymer to form a crosslinking unit in the curable fluorine-based elastomer and the optional curable fluorine-based plastic, and examples thereof include, but not limited to, biphenyl compounds having functional groups that may be used alone or in combination of two or more of them. Among these, bisaminophenol compounds are preferable from the perspective of reactivity, heat resistance, and the like.

### Bisaminophenol Compound

Examples of the bisaminophenol compound include, but not limited to, the compound represented by General Formula (1):

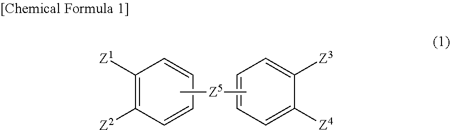

(wherein Z¹, Z², Z³, and Z⁴ are each independently a —NH₂ group or a —OH group, one of Z¹ and Z² is a —NH₂ group and the other is a —OH group, and one of Z³ and Z⁴ is a —NH₂ group and the other is a —OH group, and Z⁵ is a single bond, —O—, —CO—, —SO₂—, or a divalent group selected from the group consisting of perfluoroalkylene groups with a carbon number of from 1 to 3).

In a preferred aspect, Z⁵ is a perfluoroalkylene group with a carbon number of 1 to 3 from the perspective of ability to impart particularly favorable surface properties, flexibility, rubber elasticity, and the like to the molded product to be obtained.

In a preferred aspect, the bisaminophenol compound is 4,4′-(hexafluoroisopropyridine)bis(2-aminophenol), which may be referred to as BOAP, from the perspective of very easy availability and achieving good crosslinking reactivity.

In another preferred aspect, the bisaminophenol compound is bis(3-amino-4-hydroxyphenyl)sulfone from the perspective of very easy availability and achieving good crosslinking reactivity.

### Crosslinking Aid

The crosslinking aid used in the composite of the present disclosure may be any crosslinking aid as long as it is in the form of an organic onium salt, and may be used alone or in combination of two or more of them. Such crosslinking aid may be referred to as, for example, “catalyst”, “acid acceptor”, or “initiator”.

### Organic Onium Salt

The organic onium salt is a generic name for salt compounds including cationic and anionic components that are protonated by hydrogenation, and is not particularly limited to specific ones. Specific examples include ammonium salts, phosphonium salts, sulfonium salts, fluoronium salts, chloroonium salts, bromonium salts, and iodonium salts.

Examples of the cationic components in the organic onium salts include, but not limited to, ammonium cations, phosphonium cations, sulfonium cations, fluoronium cations, chloronium cations, bromonium cations, and iodonium cations. Among these, ammonium cations and phosphonium cations are preferable from the perspective of reactivity, heat resistance, and the like.

Examples of the anionic component in the organic onium salt include, but not limited to, anionic components having at least one trifluoromethyl group (—CF₃). Among these, from the perspective of reactivity, heat resistance, and the like, the anionic component is an anionic component having a quaternary carbon, wherein at least one of the groups surrounding the quaternary carbon is preferably a trifluoromethyl group, and more preferably at least two are trifluoromethyl groups.

Alternatively, for example, the compound represented by General Formula (2) may be used:

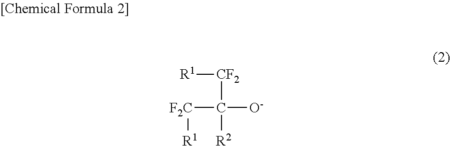

In Formula (2), each R′ is independently H, a halo atom (e.g., F, Cl, or Br), alkyl, aryl, aralkyl, or cycloalkyl, and may be halogenated, partially fluorinated, or perfluorinated, two or more of the R¹ and R² groups may form a ring together, each R′ group may independently contain one or more heteroatoms, and R² may be the same as or different from R′. When R² is the same as R′, R² is preferably not a halo atom.

Specifically, for example, each R′ may F, and R² may be a group selected from H, phenyl, methoxyphenyl, toluyl, phenoxy, fluorophenyl, trifluoromethylphenyl, and CF₃. Among these, a toluyl group (CH₃C₆H₄—) or a CF₃ group is preferable as R² from the perspective of reactivity, heat resistance, and the like.

From the perspective of reactivity, heat resistance, and the like, the organic onium salt is preferably a salt of an alcohol having at least one trifluoromethyl group and onium, and more preferably a salt of (trifluoromethyl)benzyl alcohol or perfluoro-t-alcohol and tetramethyl ammonium or tetrabutyl phosphonium, and particularly preferably at least one selected from a salt of 4-methyl-α, α-bis(trifluoromethyl)benzylmethanol and tetrabutyl phosphonium, and a salt of perfluoro-t-butanol and tetramethyl ammonium.

### Loading of Crosslinking Agent and Crosslinking Aid

In the composite of the present disclosure, the total content of the crosslinking agent and the crosslinking aid may be about 0.5 parts by mass or greater, about 0.8 parts by mass or greater, or about 1 part by mass or more, and about 3 parts by mass or less, or about 2 parts by mass or less with reference to 100 parts by mass of the curable fluorine-based polymer.

Here, “per 100 parts by mass of the curable fluorine-based polymer” refers to “per 100 parts by mass of all components contained in the curable fluorine-based polymer and having a curing site that reacts with the crosslinking agent.” For example, in a case where only a curable fluorine-based elastomer is included as the curable fluorine-based polymer, it means “with reference to 100 parts by mass of the curable fluorine-based elastomer”; in a case where the curable fluorine-based elastomer and the curable fluorine-based plastic are included, it means “with reference to 100 parts by mass of the curable fluorine-based elastomer and the curable fluorine-based plastic”.

The blending ratio of the crosslinking agent and the crosslinking aid may be from about 2:about 8 to about 7:about 3, preferably from about 2:about 8 to about 6:about 4, and more preferably from about 3:about 7 to about 6:about 4 from the perspective of reactivity, heat resistance, and the like.

The ratio of the crosslinking agent and the crosslinking aid may be defined for each type. For example, when the crosslinking agent is 4,4′-(hexafluoroisopropyridine)bis(2-aminophenol) and the crosslinking aid is a salt of perfluoro-t-butanol and tetramethyl ammonium, the ratio of the crosslinking agent:the crosslinking aid is preferably from about 2:8 to about 6:4, and more preferably from about 3:7 to about 6:4 from the perspective of reactivity, heat resistance, and the like.

When the crosslinking agent is 4,4′-(hexafluoroisopropyridine)bis(2-aminophenol) and the crosslinking aid is a salt of 4-methyl-α, α-bis(trifluoromethyl)benzylmethanol and tetrabutyl phosphonium, the ratio of the crosslinking agent:the crosslinking aid is preferably about 2:8 to about 7:3, and more preferably from about 2:8 to about 6:4 from the perspective of reactivity, heat resistance, and the like.

### Optional Component

The curable fluorine-based elastomer composite of the present disclosure may include, as optional components, for example, release agents, fillers, conductive agents, thermally conductive agents, antioxidants, ultraviolet absorbers, photostabilizers, thermal stabilizers, dispersants, plasticizers, lubricants, surfactants, leveling agents, fluorine-based silane coupling agents, catalysts different from the above-described crosslinking aid, pigments, and dyes within a range that does not affect the effects of the present invention. Among these, fillers such as silica (e.g., fumed silica) are preferred from the perspective of improving properties of the cured product to be obtained such as strength.

The composite of the present disclosure may further include other polymers different from the fluorine-based polymer (e.g., polyolefins) within a range that does not affect the effects of the present invention. However, from the perspective of long-term high temperature resistance and the like, the loading of the other polymer is preferably about 10 mass % or less, about 5 mass % or less, or about 1 mass %, and other polymers are preferably not included.

### Cured Product of Curable Fluorine-Based Elastomer Composite

The curable fluorine-based elastomer composite of the present disclosure includes a specific crosslinking agent and a specific crosslinking aid at a specific ratio, so that the cured product obtained from the composite (hereinafter may be simply referred to as “cured product”) have sufficient properties such as long-term high temperature resistance without significantly decreasing the properties of the elastomer itself, such as chemical resistance and rubber elasticity.

### Properties of Cured Product

### Long-Term High Temperature Resistance: Compression Set

The cured product of the present disclosure has sufficient long-term high temperature resistance. The high temperature resistance can be evaluated by, for example, visually observing the crack generation state and the molten state of the cured product after the cured product has been held for a predetermined amount of time in a high temperature environment. Here, the test piece after exposure to a high temperature environment, for example, the high-temperature environment in the compression set measurement test described below, is observed, and if the entire surface of the test piece melts and exhibits adhesiveness, it can be determined as “melting.”

Alternatively, the high temperature resistance can be evaluated with a compression set in accordance with JIS K6262. In this case, the compression set of the cured product after being held at 300° C. for 14 days can be defined as about 88% or less, about 80% or less, or about 70% or less, and can be defined as about 20% or greater, about 25% or greater, or about 30% or greater.

### Application

The cured product of the present disclosure has excellent properties such as heat resistance, chemical resistance, and plasma resistance, and thus can be used in various applications. For example, it can be used in, but not limited to, the applications in a high temperature environment at about 200° C. or higher, about 220° C. or higher, about 250° C. or higher, about 280° C. or higher, or about 300° C. or higher, and/or in an environment exposed to chemicals, particularly in an environment exposed to an acidic atmosphere or an acidic solution, and/or in an environment exposed to plasma (e.g., plasma of O₂, CF₄, or NF₃).

Specifically, examples of members used in vehicles, ships, aircraft, various manufacturing devices, and chemical or fuel transport include vacuum pads used for adsorbing and transporting articles such as display panels and semiconductor wafers; various sealing materials such as O-rings, packings, and gaskets; and other members such as joints, adapters, pipes, hoses, belts, tubes, and rollers. Among these, the cured product of the present disclosure is preferably used as a sealing material for high temperature environments. The sealing material for high temperature environments refers to, for example, a sealing material used in high temperature environments at about 200° C. or higher, about 220° C. or higher, about 250° C. or higher, about 280° C. or higher, or about 300° C. or higher, for example, a sealing material used in semiconductor manufacturing devices (in particular, a plasma etching device composing such a device, a device with a plasma environment such as a plasma CVD device, etc.), and engines.

In this manner, the form of the cured product may be any form, and it may be appropriately used in other forms such as coatings, films, plates, containers, various types of jigs, valves, mixing blades, and cooking equipment. These molded products can be appropriately formed using known methods such as coating methods, injection molding methods, compression molding, and extrusion methods.

When used in such applications, the cured products may be used alone or in combination with other parts or in laminate configurations. Examples of the laminate configuration include a configuration in which a cured product layer is applied to one or both surfaces of a reinforcing layer or a support layer such as a polyamide fabric, and a configuration in which an adhesive layer such as a pressure-sensitive adhesive is applied to the cured product layer.

Method for Producing Curable Fluorine-Based Elastomer Composite and Cured Product Thereof

The method for producing the curable fluorine-based elastomer composite of the present disclosure is not particularly limited. For example, it can be prepared by adding a crosslinking agent, a crosslinking aid, and optionally the optional components described above to the curable fluorine-based elastomer as a curable fluorine-based polymer in any order, and mixing them thoroughly Mixing of these components can be performed using, for example, a two-roll mill (open roll mill), a kneader, a Banbury mixer, a twin screw kneading extruder, or any other mixer or kneader.

The composite can be processed and molded, for example, by extrusion molding or in the form of a sheet or an O-ring, for example, the composite can be processed and molded by a molding method.

Molding or press curing of the composite is typically carried out under appropriate pressure at a temperature sufficient to cure for the desired time. Generally, the temperature may be from about 95° C. to about 230° C., preferably from about 120° C. to about 205° C., and the period may be from about 1 minute to about 15 hours, typically from about 5 minutes to about 30 minutes. The pressure may typically be from about 700 kPa (0.7 MPa) to about 21000 kPa (21 MPa). The mold may be coated with a release agent and baked in advance.

This molded composite or pressurized cured article is then typically post cured, for example, in a heating oven at a temperature and for a time sufficient to complete curing. Generally, the temperature may be from about 150° C. to about 300° C. (e.g., about 230° C.), and the time is about 2 hours or more, and in some cases about 50 hours or more, but generally about 2 hours to about 50 hours, though it varies depending on the cross-sectional thickness of the molded composite or the pressure-cured article (generally the time increases with the increase of the cross-sectional thickness).

### EXAMPLES

### Examples 1 to 9 and Comparative Examples 1 to 10

Specific embodiments of the present disclosure are exemplified in the following examples, but the present invention is not limited to these embodiments.

The products and the like used in Examples are illustrated in Table 1 below.

TABLE 1

| Abbreviation or trade | | |
|---|---|---|
| name | Description | Structural formula |
| Curable fluorine-based | A copolymer (curable perfluoroelastomer) | |
| polymer A | of 65.7 mol% of TFE, 33.0 mol% of PMVE, | |
| | and 1.3 mol% of MV5CN made by aqueous | |
| | emulsion polymerization. | |
| Curable fluorine-based | A mixture of 80% by mass of a copolymer | |
| polymer B | (curable perfluoroelastomer) of 65.7 mol% | |
| | of TFE, 33.0 mol% of PMVE, and 1.3 | |
| | mol% of MV5CN made by aqueous | |
| | emulsion polymerization, and 20% by mass | |
| | of a copolymer (curable fluorine-based | |
| | plastic) of 95.3 mol% of TFE, 3.9 mol% of | |
| | PPVE, and 0.8 mol% of MV5CN made by | |
| | aqueous emulsion polymerization. | |
| Crosslinking agent A | 4,4′-(hexafluoroisopropyridine)bis(2- aminophenol). BOAP | 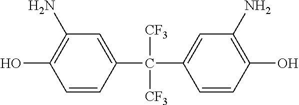 [SMILES: Nc1cc(C(c2ccc(O)c(N)c2)(C(F)(F)F)C(F)(F)F)ccc1O] |
| Crosslinking agent B | 2,2,3,3-tetrafluoro-3-(trifluoromethoxy)- propane imideamide, 2,2,2-trifluoroacetate | 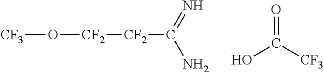 |
| Crosslinking aid A | A salt of perfluoro-t-butanol and tetramethyl ammonium. | 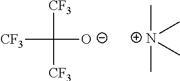 |
| Crosslinking aid B | A salt of 4-methyl-α, α- bis(trifluoromethypbenzylmethanol and tetrabutyl phosphonium (1:1). | 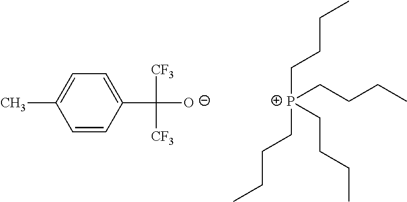 [SMILES: Cc1ccc(C([O-])(C(F)(F)F)C(F)(F)F)cc1 ; CCCC[P+](CCCC)(CCCC)CCCC] |
| AEROSIL (trade | Hydrophobic fumed silica. Nippon Aerosil | |
| name) R972 | Co., Ltd. | |

The materials shown in Table 1 were mixed using a two-roll mill at the blending ratios shown in Table 2 to 5 to prepare curable fluorine-based elastomer composites. The numerical values in Tables 2 to 5 are all in units of parts by mass.

### Evaluation Test

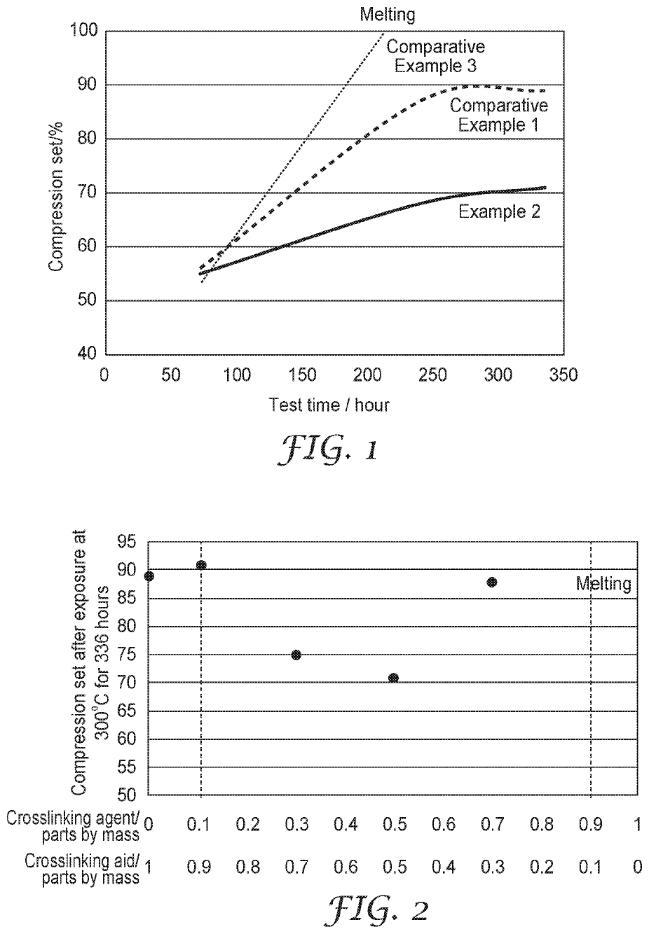

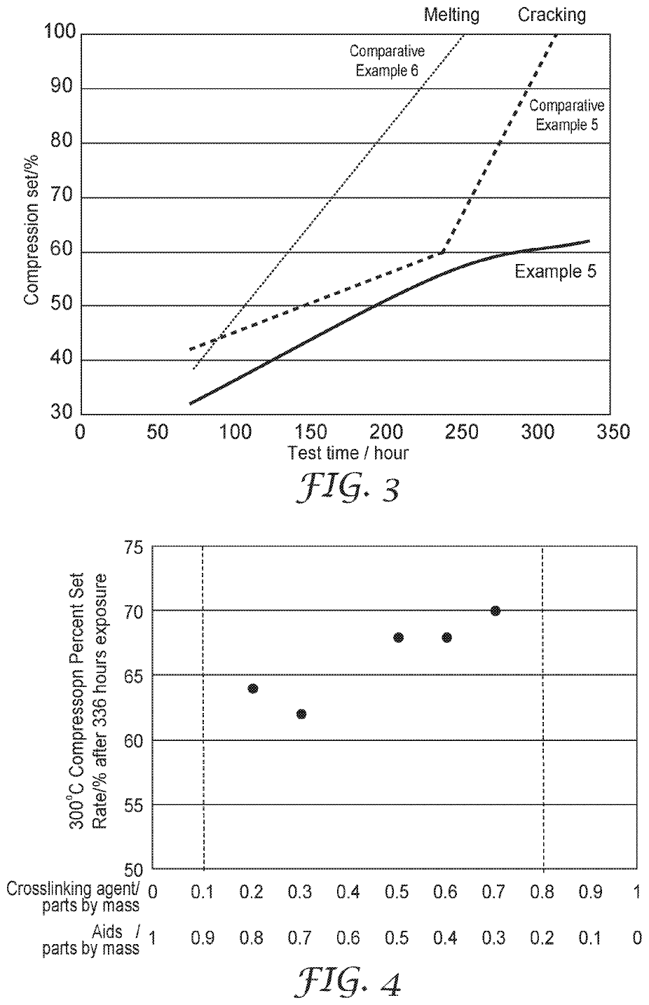

Long-term high temperature resistance of the cured products obtained from the curable fluorine-based elastomer composites were evaluated using the following method. The results are shown in Table 2 to Table 5 and FIG. 1 to FIG. 6. Here, the graphs of Comparative Examples 3, 5 and 6 in FIG. 1 and FIG. 3 are partially imaged because they caused cracking or melting under certain conditions.

### Method for Preparing Test Piece

Each of the composite was placed in an O-ring shaped mold conforming to JIS B2401 P-26 and pressure-cured under application of a pressure of about 20 MPa under the conditions set forth in each table. Subsequently, the obtained molded product was subjected to step curing under predetermined conditions in an air circulation oven, and then cooled to room temperature over about 2 hours to prepare an O-ring shaped test piece.

Here, the step curing in Examples in Table 2 to Table 5 used the conditions including: 1) the temperature was increased from room temperature to 150° C. over 2 hours; 2) the temperature was held at 150° C. for 7 hours; 3) the temperature was increased from 150° C. to 280° C. over 1 hour; 4) the temperature was held at 280° C. for 4 hours; and 5) the temperature was decreased from 280° C. to room temperature over 2 hours.

### Long-Term High Temperature Resistance: Compression Set

The compression set (hereinafter may be referred to as “C/set”) was measured in accordance with JIS K6262). Specifically, an O-ring-shaped test piece was placed between two flat steel plates using a steel plate spacer having a standard height, and the test piece was compressed until its height became 75% with reference to the initial height. The compression device including the test piece, spacer, and steel plate was closed with a bolt, and it was allowed to stand in an oven at a predetermined temperature for a predetermined time as described in each table. The device was then removed from the oven and the test piece was immediately released from the device. The height of the test piece 30 minutes after the release was measured, and the compression set was calculated by Formula (3) below:

$$\begin{matrix}[ Equation 1 ] & \\ Compression set ( \% ) = \frac{H ( i ) - H ( c )}{( 1 - 0.75 ) \times H ( i )} \times 100. & ( 3 )\end{matrix}$$

The H(i) is the initial height of the test piece, and H(c) is the height of the test piece after the compression test. In addition, the value of the compression set ratio in each table is the average value of the numerical values obtained from the three test pieces, and the lower the numerical value of the compression set, the higher the recovery ratio, or more excellent the long-term high temperature resistance.

TABLE 2

| | | Compar- | Compar- | | | | Compar- | Compar- |
|---|---|---|---|---|---|---|---|---|
| | | ative | ative | Example | Example | Example | ative | ative |
| | | Example 1 | Example 2 | 1 | 2 | 3 | Example 3 | Example 4 |
| Composition | Curable fluorine- | 100 | 100 | 100 | 100 | 100 | 100 | 100 |
| of composite | based polymer A | | | | | | | |
| | Crosslinking aid A | 1 | 0.9 | 0.7 | 0.5 | 0.3 | 0.1 | 0 |
| | Crosslinking agent A | 0 | 0.1 | 0.3 | 0.5 | 0.7 | 0.9 | 1 |
| Curing | Pressure curing | 180° C., | 180° C., | 180° C., | 180° C., | 180° C., | 180° C., | 180° C. |
| conditions | | 30 minutes | 30 minutes | 30 minutes | 30 minutes | 30 minutes | 30 minutes | 30 minutes |
| | Post curing | Step | Step | Step | Step | Step | Step | Step |
| | | curing | curing | curing | curing | curing | curing | curing |

| | | | | | | | |
|---|---|---|---|---|---|---|---|
| C/set (%), 300 °C., 72 hours | 56 | 58 | 55 | 55 | 56 | 52 | 49 |
| C/set (%), 300 °C., 240 hours | 87 | 89 | 72 | 68 | 82 | Melting | Melting |
| C/set (%), 300 °C., 336 hours | 89 | 91 | 75 | 71 | 88 | Melting | Melting |

### Results

As indicated by the results of Table 2, FIG. 1 and FIG. 2, the cured products of Examples 1 to 3 obtained from the composite including a specific crosslinking agent and a specific crosslinking aid at a specific ratio exhibited excellent long-term high temperature resistance, particularly high temperature resistance at 300° C. for 336 hours (14 days) without causing cracking or melting, in comparison with the cured products of Comparative Examples 1 to 4 obtained from the composite not including these agents at a specific ratio.

TABLE 3

| | | Compar- | | | | | | Compar- |
|---|---|---|---|---|---|---|---|---|
| | | ative | Example | Example | Example | Example | Example | ative |
| | | Example 5 | 4 | 5 | 6 | 7 | 8 | Example 6 |
| Composition | Curable fluorine- | 100 | 100 | 100 | 100 | 100 | 100 | 100 |
| of composite | based polymer A | | | | | | | |
| | Crosslinking aid B | 0.9 | 0.8 | 0.7 | 0.5 | 0.4 | 0.3 | 0.2 |
| | Crosslinking agent A | 0.1 | 0.2 | 0.3 | 0.5 | 0.6 | 0.7 | 0.8 |
| Curing | Pressure curing | 180° C., | 180° C., | 180° C., | 180° C., | 180° C., | 180° C., | 180° C. |
| conditions | | 30 minutes | 30 minutes | 30 minutes | 30 minutes | 30 minutes | 30 minutes | 30 minutes |
| | Post curing | Step | Step | Step | Step | Step | Step | Step |
| | | curing | curing | curing | curing | curing | curing | curing |

| | | | | | | | |
|---|---|---|---|---|---|---|---|
| C/set (%), 300° C., 72 hours | 42 | 36 | 32 | 34 | 36 | 40 | 39 |
| C/set (%), 300° C., 240 hours | 60 | 57 | 56 | 60 | 62 | 59 | Melting |
| C/set (%), 300° C., 336 hours | 69 (1/3 | 64 | 62 | 68 | 68 | 70 | Melting |
| | cracking^{a)}) | | | | | | |

^{a)}Cracking occurred in one of the three test pieces.

### Results

As indicated by the results of Table 3, FIG. 3, and FIG. 4, even though the organic onium salt (crosslinking aid) different from that of Examples 1 to 3 was used, if the crosslinking agent and the crosslinking aid were included in the composite at a specific ratio, the obtained cured product exhibited excellent long-term high temperature resistance, particularly high temperature resistance at 300° C. for 336 hours without causing cracking or melting.

It was also confirmed that an aspect using a salt of 4-methyl-α, α-bis(trifluoromethyl)benzylmethanol and tetrabutyl phosphonium as the crosslinking aid achieved more excellent long-term high temperature resistance in comparison with an aspect using a salt of perfluoro-t-butanol and tetramethyl ammonium.

TABLE 4

| | | Comparative | Comparative | Comparative |
|---|---|---|---|---|
| | | Example 7 | Example 8 | Example 9 |
| Composition of | Curable fluorine-based | 100 | 100 | 100 |
| composite | polymer A | | | |
| | Crosslinking aid B | 1 | 0.5 | 0.5 |
| | Crosslinking agent A | 0 | 0.5 | 0.5 |
| | AEROSIL R972 | 0 | 0 | 1 |
| Curing conditions | Pressure curing | 165° C., | 165° C., | 165° C., |
| | | 30 minutes | 30 minutes | 30 minutes |
| | Post curing | Step curing | Step curing | Step curing |

| | | | |
|---|---|---|---|
| C/set (%), 300° C., 72 hours | 47 | 23 | 20 (1/3 cracking^{b)}) |
| C/set (%), 300° C., 240 hours | Cracking^{a)} | 48 (1/3 cracking^{b)}) | 50 (1/3 cracking^{b)}) |
| C/set (%), 300° C., 336 hours | Cracking^{a)} | 60 (2/3 cracking^{c)}) | 67 (2/3 cracking^{c)}) |

^{a)}Cracking occurred in all three test pieces.
^{b)}Cracking occurred in one of the three test pieces.
^{c)}Cracking occurred in two of the three test pieces.

### Results

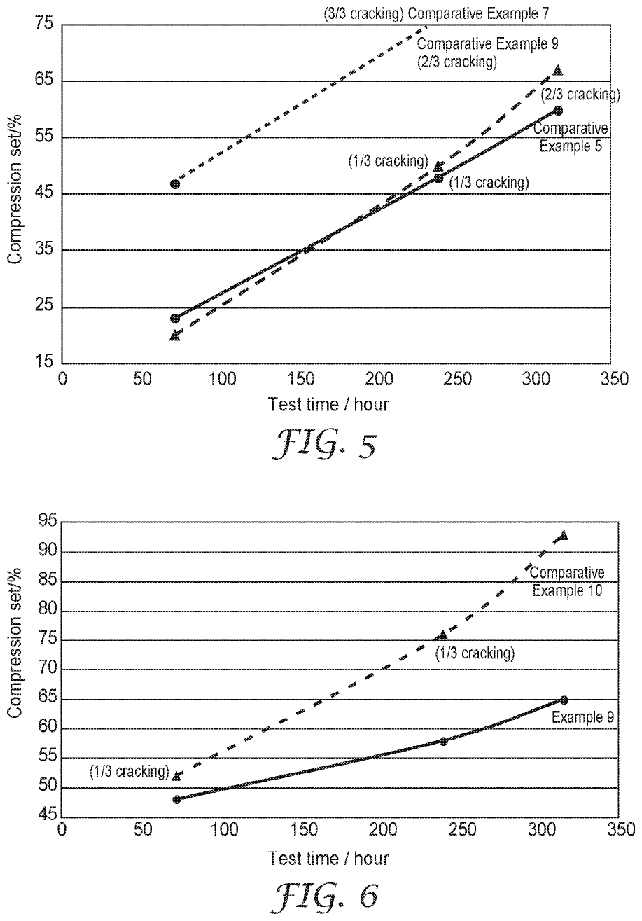

The aspects of Comparative Examples 7 to 9 correspond to the configuration of Patent Document 1. As indicated by the results of Table 4 and FIG. 5, the cured product of this configuration exhibited high temperature resistance at 300° C. for up to 72 hours when it included no filler, but did not exhibit long-term high temperature resistance for a longer period.

TABLE 5

| | | Comparative Example 10 | Example 9 |
|---|---|---|---|
| Composition of composite | Curable fluorine-based | 100 | 100 |
| | polymer B | | |
| | Crosslinking aid B | 1 | 0.5 |
| | Crosslinking agent A | 0 | 0.5 |
| Curing conditions | Pressure curing | 180° C., | 180° C., |
| | | 30 minutes | 30 minutes |
| | Post curing | Step curing | Step curing |

| | | |
|---|---|---|
| C/set (%), 300° C., 72 hours | 52 (1/3 cracking^{a)}) | 48 |
| C/set (%), 300° C., 240 hours | 76 (1/3 cracking^{a)}) | 58 |
| C/set (%), 300° C., 336 hours | 93 | 65 |

^{a)}Cracking occurred in one of the three test pieces.

### Results

As indicated by the results of Table 5 and FIG. 6, even when the composite included, as curable fluorine-based polymers, a curable fluorine-based plastic exhibiting no rubber elasticity in addition to a curable fluorine-based elastomer, the obtained cured product exhibited excellent long-term high temperature resistance, especially at 300° C. for 336 hours, without causing cracking or melting.

It will be apparent to those skilled in the art that various modifications can be made to the embodiments and examples described above without departing from the basic principles of the present invention. It will also be apparent to those skilled in the art that various improvements and modifications of the present invention can be made without departing from the gist and scope of the present invention.

1. A curable fluorine-based elastomer composite, comprising:
a curable fluorine-based polymer comprising a curable fluorine-based elastomer including a copolymerization unit having a curing site;
a crosslinking agent that reacts with the curing site of the elastomer to form a crosslinking unit in the elastomer; and
a crosslinking aid including an organic onium salt, wherein the organic onium salt is a salt of (trifluoromethyl)benzyl alcohol and tetramethyl ammonium or tetrabutyl phosphonium, and wherein the total content of the crosslinking agent and the crosslinking aid is about 0.5 parts by mass or more and about 3 parts by mass or less with reference to 100 parts by mass of the curable fluorine-based polymer, and the ratio between the crosslinking agent and the crosslinking aid is from about 2:8 to about 7:3.

2. The composite of claim 1, wherein the curable fluorine-based elastomer composite further comprises a curable fluorine-based plastic including a copolymerization unit having a curing site, the curing site of the curable fluorine-based plastic is a site that reacts with the crosslinking agent to form a crosslinked unit in the plastic.

3. The composite of claim 1, wherein the curing site of the elastomer is a cyano group.

4. The composite of claim 1, wherein the curable fluorine-based elastomer is a curable perfluoroelastomer.

5. The composite of claim 1, wherein the crosslinking agent is a bisaminophenol compound.

6. The composite according to claim 5, wherein the bisaminophenol compound is

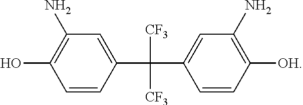 [SMILES: Nc1cc(C(c2ccc(O)c(N)c2)(C(F)(F)F)C(F)(F)F)ccc1O]

7. The composite of claim 1, wherein the organic onium salt is a salt of 4-methyl-α, α-bis(trifluoromethyl)benzylmethanol and tetrabutyl phosphonium.

8. The composite of claim 1, wherein the composite further comprises a filler.

9. A cured product according to the composite of claim 1, wherein the cured product has a compression set of 88% or less without causing cracking or melting after being held at 300° C. for 14 days, wherein the compression set is measured in accordance with JIS K6262.

10. A sealing material for high temperature environments obtained from a cured product of the composite of claim 1.

11. (canceled)

12. The composite of claim 2, wherein the curing site of the elastomer is a cyano group.

13. The composite of claim 2, wherein the curable fluorine-based elastomer is a curable perfluoroelastomer.

14. The composite of claim 2, wherein the crosslinking agent is a bisaminophenol compound.

15. The composite according to claim 14, wherein the bisaminophenol compound is

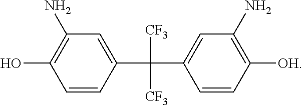 [SMILES: Nc1cc(C(c2ccc(O)c(N)c2)(C(F)(F)F)C(F)(F)F)ccc1O]

16. The composite of claim 2, wherein the organic onium salt is a salt of 4-methyl-α, α-bis(trifluoromethyl)benzylmethanol and tetrabutyl phosphonium.

17. The composite of claim 2, wherein the composite further comprises a filler.
